(19) United States
(12) Patent Application Publication
(10) Pub. No.: US 2011/0089109 A1
(43) Pub. Date: Apr. 21, 2011

(54) Method for treatment of sludge

(76) Inventors: Hans David Ulmert, Lund (SE); Stefan Jâfverström, Norrkoping (SE); Kjell Stendahl, Helsingborg (SE)

(21) Appl. No.: 10/575,806

(22) PCT Filed: Oct. 18, 2004
(86) PCT No.: PCT/SE04/01497

§ 371 Date: Aug. 16, 2010

(30) Foreign Application Priority Data
Oct. 17, 2003 (SE) 0302754-7
Feb. 26, 2004 (SE) 0400450-3
Jul. 19, 2004 (SE) 0401887-5

(51) Int. Cl. C02F 11/00; C02F 1/52; C02F 1/44

(52) U.S. Cl. 210/638; 210/198.1

(57) ABSTRACT

Method for treatment of sludge, which includes precipitated aluminium and/or iron hydroxide, whereby the sludge first is added acid and thereafter is subjected to at least one membrane filtration process, whereby a permeate or a concentrate is obtained, including trivalent aluminium and/or iron ions in solution. The aluminium and/or iron ions in the permeate, or concentrate, are crystallised (salting out) in a precipitation.

### TECHNICAL FIELD

The invention relates to treatment of sludge from waterworks, and similar sludge from industrial processes, such as paper industry. More specifically, the invention relates to a method and a construction for treatment of sludge, which includes aluminium- and iron hydroxide, at which an acid first is added to said sludge, and said sludge thereafter is subjected to at least one membrane filtration process.

### PRIOR ART

When pure water is to be obtained from surface water, suspended matter and organic material must be separated. Such organic material is mostly a brownish substance, so called humus substances. These substances are formed during incomplete breakdown of dead vegetables and occur naturally in a varying amount in lakes and watercourses.

A separation of suspended matter lowers the turbidity of the water and a separation of humus reduces the discoloration of the water.

To be able to accomplish this separation it is common to add inorganic chemical coagulants, such as trivalent metallic salts of iron and aluminium. The metallic ions formed in this connection, during mild stirring, flocks of hydroxide, that encase and adsorb the suspended material and the in water solved organic substances.

After terminated flocculation the formed flocks are separated in different ways, such as flotation/sandfiltration, sedimentation/sandfiltration, or merely sandfiltration. The separated flocks are pumped as thin sludge out from the construction, directly back to the recipient or to a sludge lagun. Optionally the sludge is dewatered, for example in a centrifuge, to be deposited thereafter. In warm countries the sludge may be laid on drying beds, to be deposited thereafter.

Another alternative method to take care of the thin sludge is to add acid, preferably sulphuric acid. When adding a sufficient amount acid the metallic hydroxide, which was obtained during the flocculation process, is dissolved in such way that metallic ions are obtained, mainly Fe³⁺ and Al³⁺. When the metallic hydroxide has been dissolved a sludge mixture with low pH is thus obtained, that includes suspended matter, organic substances and inorganic ions. This sludge mixture may then be filtrated in a membrane filtration process, in such way that a concentrate and a permeate are obtained. As a result, said permeate includes mainly the inorganic chemical coagulants in solution.

In this context the term “membrane filtration process” concerns a separation process, wherein the driving force consists of a difference in chemical potential over the membrane. The driving force—the chemical potential—may be obtained in different ways in different membrane processes; it may be an applied pressure, a difference in concentration or in temperature, or a difference in electric potential. The separation mechanism is based on a solution theory, in which the solubility of the dissolved substances and the diffusivity in the membrane are decisive.

Different types of membranes are used in the different membrane processes. In a lot of processes membranes with large pores are used (for example micro filtration), while the membranes in other processes have small pore (for example reversed osmosis). Some processes are based on the fact that the membranes are charged (for example nano filtration), while the possible charge of the membranes does not affect the main separation mechanism in other processes (for example micro filtration). Thus, the sludge mixture is led to a first construction for membrane filtration, which may be a construction for ultra filtration or a construction for micro filtration.

During ultra filtration (UF) the size of the particles mainly decides what will be separated and what will pass through the membrane. Thus, the sieving mechanism dominates, but diffusion and interaction between membrane and the dissolved substances are also of importance. The separation with micro filtration (MF) is totally based on a sieving mechanism, and the size of the pores is the decisive factor in respect of what will pass through the membrane.

Thus, the sludge mixture is pumped through a MF construction or a UF construction. The MF construction separates mainly suspended substances and colloids, but not dissolved organic substances, while the UF construction also separates bigger organic molecules.

The filtration, by a MF/UF membrane filtration construction, thus results in a concentrate, including mainly suspended matter and organic compounds, that can not pass through the filter, and a permeate, including mainly water with inorganic ions, such as Fe³⁺ and Al³⁺, which pass through said filter. In this manner up to 90% of the used amount of aluminium and iron ions in the flocculation process may be recovered in said permeate. The permeate may therefore be used as chemical coagulant in both wastewater treatment plants and waterworks. However, the permeate will also include dissolved organic substances with low molecular weight and such heavy metals that, just as aluminium and iron ions, have been dissolved during the acid treatment. This is a disadvantage. Both heavy metals and organic substances will therefore accumulate in the system and constantly increase in respect of concentration, which may result in a deteriorating quality on the treated water. Since water is classified as a foodstuff, also the public health board and the public may raise objections against that not a totally “clean” product is used as chemical coagulants in waterworks. However, the same problem do not arise if the same obtained permeate is used as chemical coagulant during treatment of wastewater, which is not used as drinking-water.

To increase the amount of aluminium and iron ions in said permeate a concentration process may be performed in a nano filtration construction (NF), or in a reversed osmosis construction (RO). During NF substances are separated according to two separation processes. Uncharged substances are separated in respect of size, while possible retention of ions depend on the electrical interaction between ion and membrane. Thus, if the permeate is filtered with a NF construction the trivalent ions, i.e. Fe³⁺ and Al³⁺, will be retained in the concentrate, while ions with lower charge in some extent will pass through the membrane and thus retrieved in the permeate. If an additional concentration process is performed by a RO construction also ions with lower charge will be retained in the concentrate, while the permeate is almost free from ions. The obtained concentrate, both from a NF construction and from a RO construction, may be re-used as chemical coagulant, but with the same reservation that was brought forward in accordance with UF/MF permeate.

To be able to re-use the from membrane processes recovered iron and/or aluminium ions as chemical coagulants in waterworks, an additional purification in respect of organic substances and heavy metals has to be performed.

U.S. Pat. No. 5,674,402 describes a process wherein the concentration is obtained by precipitation of Al, in form of alunite, which means that alunite on one hand has to be reprocessed, by dissolving the alunite in acid, to obtain a water soluble chemical coagulant, and on the other hand has to be calcinated, to get rid of co-precipitated organic matter. Furthermore, precipitation of alunite does not give a product that is free from heavy metals, which results in that it may be difficult to fulfil the demands on chemical substances in drink-water by this process.

### SUMMARY OF THE INVENTION

An object with the present invention is to provide a method that produce in pure form a product, including iron and/or aluminium ions, which has been obtained from waterworks, or similar sludge from industrial processes, such as paper industry, by membrane processes, in such way that the purified product may be used as chemical coagulant in waterworks, similar industrial processes, such as paper industry, and/or wastewater treatment plants.

Another object with the present invention is to provide a method that makes it possible to re-use chemical coagulant from the sludge in waterworks.

Another object with the present invention is to provide a method that reduces the need of chemical coagulant in waterworks.

Still another object with the present invention is to obtain a product with high concentration of aluminium and/or iron ions, which will reduce transportation costs.

Another object with the present invention is to use a residual product for phosphorous reduction in wastewater treatment plants.

To fulfil these objects a method and a construction have obtained the characterising features in accordance with claims 1 to 16.

### BRIEF DESCRIPTION OF THE DRAWINGS

To explain the invention in further detail illustrative embodiments thereof will be described below, with reference to enclosed drawings, in which;

FIG. 1 is a flow chart of a first embodiment of the present invention including treatment of concentrate from NF/RO construction or permeate from MF/UF construction,

FIG. 2 is a diagram that shows the amount of Al in a saturated solution of alum as a function of temperature, and

FIG. 3 is a flow chart that shows separation in a alum crystallisation step.

### DETAILED DESCRIPTION OF PREFERRED EMBODIMENTS

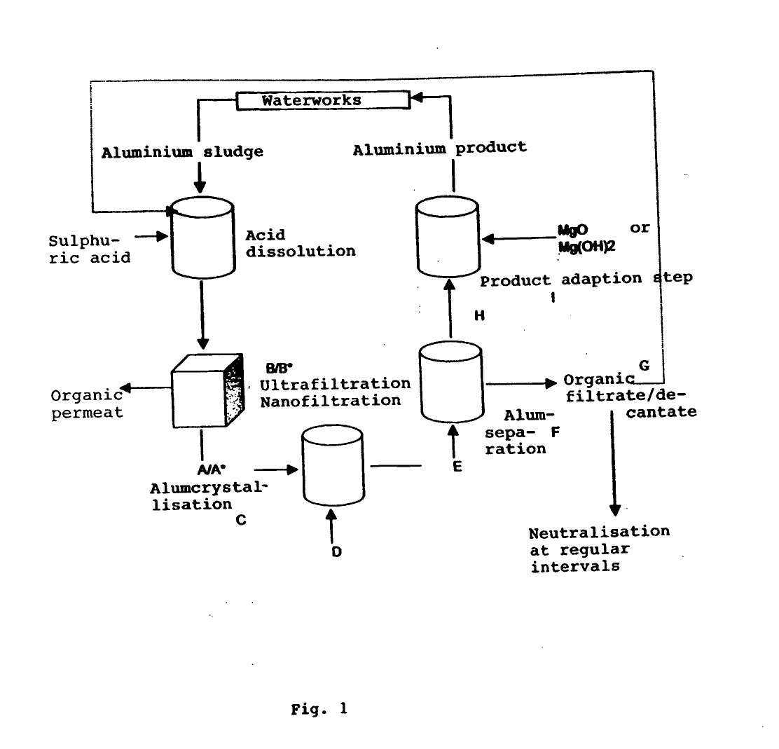

In a first embodiment of the present invention, in accordance with FIG. 1, a concentrate A is led, from a nano filtration construction (NF) or a reversed osmosis construction (RO), from a sludge treatment construction B to a alum crystallisation step C, where potassium-, sodium- and/or ammonium sulphate D is added in a stoichiometric amount or in excess. If a stoichiometric amount or an excess of potassium, sodium and/or ammonium ions, preferably in form of potassium-, sodium- and/or ammoniumsulphate, are added to the concentrate A, a crystallisation (salting out) and precipitation of alum, in form of potassium/sodium/ammonium-aluminium-sulphate and/or potassium/sodium/ammonium-iron-sulphate, will take place, in accordance with the following chemical formulas:

K⁺+Al³⁺+2SO₄²⁻+12 H₂O→KAl(SO₄)₂×12H₂O

K⁺+Fe³⁺+2SO₄²⁻+12 H₂O→KFe(SO₄)₂×12H₂O

NH₄⁺+Al³⁺+2SO₄²⁻+12 H₂O→NH₄Al(SO₄)₂×12H₂O

NH₄⁺+Fe³⁺+2SO₄²⁻+12 H₂O→NH₄Fe(SO₄)₂×12H₂O

Na⁺+Al³⁺+2SO₄²⁻+12 H₂O→NaAl(SO₄)₂×12H₂O

Na⁺+Fe³⁺+2SO₄²⁻+12 H₂O→NaFe(SO₄)₂×12H₂O

(The compounds above does also exist with 6 H₂O)

The correspondent crystallisation of divalent metallic ions does not take place, which means that these are retained in solution. This results in that the precipitated salt is fundamentally free from heavy metals, which mainly are divalent. Since also Fe exists in divalent form, Fe must first be oxidised by a suitable oxidising agent, such as ozone and hydrogen peroxide, or active chlorine, such as chlorine gas, chlorate, and sodium hypochlorite. Here oxidising compounds including active oxygen are preferred, since chlorine together with organic substances may form toxic and carcinogenic organochlorines.

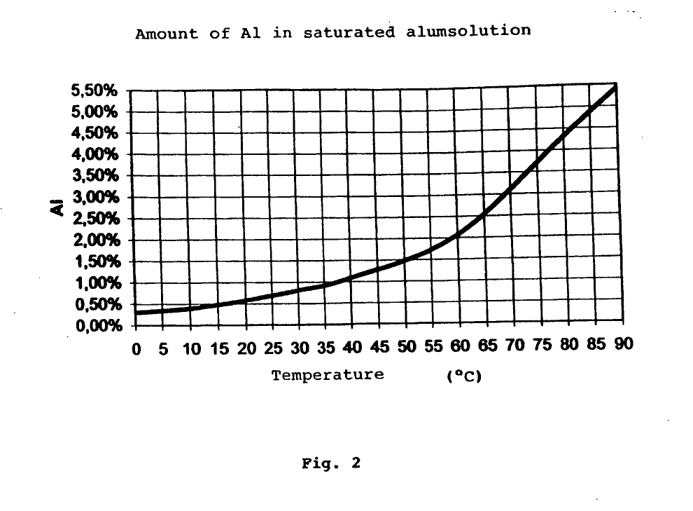

Addition and crystallisation are performed during stirring. Crystallisation of potassium/sodium/ammonium-aluminium-sulphate and/or potassium/sodium/ammonium-iron-sulphate is very temperature dependent, which for example means that an entry content of 2.5% Al results in that a saturated process solution, after addition of potassiumsulfate, at room temperature will contain 0.5% Al. With regard to the change of weight this results in a reaction yield of hardly 90% (see FIG. 2). The crystallisation in the alum crystallisation step C is preferably performed at low temperature, such as at most 25° C., and even more preferably not more than 20° C. Here the solution in the alum crystallisation step may also be performed with increased pressure and with adjustment of pH. This adjustment of pH may be performed by a suitable base, such as for example potassium hydroxide, sodium hydroxide, sodium carbonate, magnesium hydroxide, magnesium oxide, and/or magnesium carbonate. A solution E is fed out from the alum crystallisation step C to an alum separation step F.

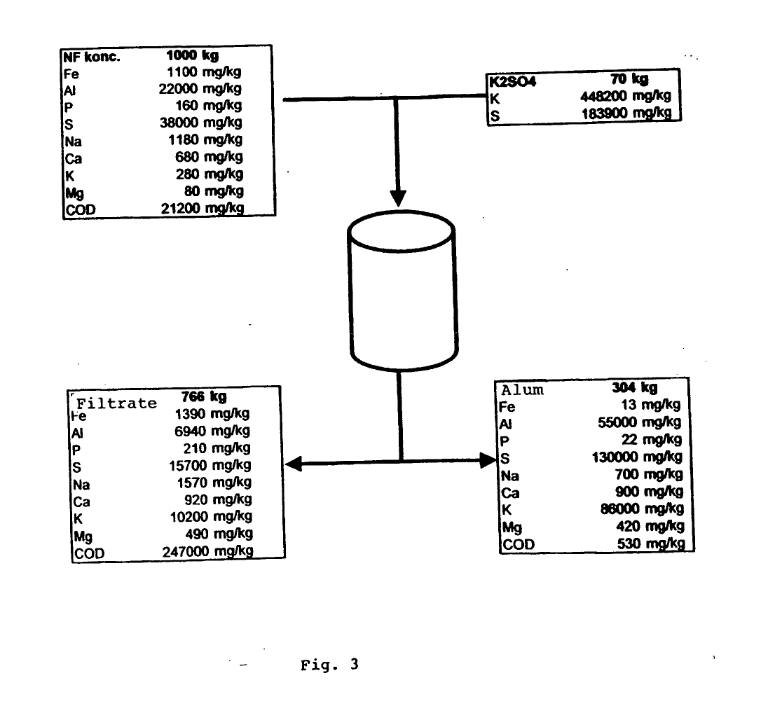

The, in the alum crystallisation step C formed, crystals have very good sedimentation and filtration properties, which result in that said crystals may be separated from contaminants, such as dissolved organic substances and divalent metals, in the alum separation step F, which is shown in FIG. 3. During a filtration a very dry filter cake is obtained, with a degree of dryness in the magnitude of 90 to 95% DS (dry substance). A filtrate G, including the organic residual and possible heavy metals, is suitably led back to an acid dissolution step in the sludge treatment construction B. In such way the aluminium yield may be improved. This means that certain metals will be accumulated in the process. Therefore, the streams should be led out from the process and be neutralised at regular intervals, especially to take care of heavy metals.

This filtrate G may for example still be used as chemical coagulant in a wastewater treatment plant, where the solution advantageously may be used in respect of simultaneous precipitation of phosphorous in biostep of the wastewater treatment plant. This is called simultaneous precipitation.

If the earlier separation has been performed in a UF filter, only smaller organic molecules will be present in the solution, where said molecules are easily decomposed in the biostep, while the remaining aluminium and/or iron ions will precipitate phosphorous.

A precipitation H, which has been separated in the alum separation step, will be able to be used right away, after dissolution in preferably warm water, to enhance the dissolution (FIG. 2), as a water purification agent, but the precipitation H is preferably led to a product adaptation step I, to obtain properties that are more adapted to meet the needs of the specific waterworks customer.

In the product adaptation step I a controlled alkalisation is performed by preferably a slurry of magnesium oxide, but also MgCO₃, Na₂CO₃, NaOH, NaAl(OH)₄ and/or KOH, in accordance with the reaction formula 1 below:

2 KAl(SO₄)₂×12H₂O+H₂O→2 K⁺+2 Al³⁺+4 SO₄²⁻+H₂O 2 K⁴+2 Al³⁺+4 SO₄²⁻ H₂O+Mg(OH)₂→2 K⁺+Al₂(OH) ₂⁴⁺+4 SO₄²⁻+H₂O+Mg²⁺ Reaction formula 1:

The alkalisation in reaction formula 1 may be expressed as molar ratio between hydroxide ions and aluminium ions OH/Al=1.0. Considering the fact that a complete alkalisation of aluminium ions has a molar ratio of OH/Al=3.0, the reaction formula 1 implies that the aluminium has a basicity or a degree of alkalisation of 33% (1/3=33.33%).

The product adaptation step I may operate over a larger region, in respect of alkalisation, which covers 0 to 82% alkalisation.

Examples of higher alkalisation may be described by reaction formulas 2 and 3 below.

2 K⁺+2 Al³⁺+4 SO₄²⁻ H₂O+1.33 Mg(OH)₂→2 K⁴+0.66 Al₃(OH)₄⁵⁺+4 SO₄²⁻+H₂O+1.33 Mg²⁺ Reaction formula 2:

Molar ration OH/Al=1.333 or degree of alkalisation=44% (1.333/3=44.44%)

2 K⁺+2 Al³⁺+4 SO₄²⁻ H₂O+2.46 Mg(OH)₂→2 K⁴ +0.15 Al₁₃O₄(OH)₂₄⁷⁺+4 SO₄²⁻+H₂O+2.46 Mg²⁺ Reaction formula 3:

Molar ratio OH/Al=2.461 or degree of alkalisation=82% (2.461/3=82.03%).

In reaction formulas 1, 2, or 3 potassium may be replaced by ammonium or sodium, and Mg(OH)₂, as the alkalising agent, may be replaced by MgO, MgCO₃, Na₂CO₃, NaOH, NaAl(OH)₄ or KOH. The most preferred as alkalising agents are Mg(OH)₂ and MgO.

By this reaction polyaluminium products, such as Al(OH)₂⁴⁺, Al₃(OH)₄⁵⁺ and/or Al₁₃O₄(OH)₂₄⁷⁺, are formed. These polyaluminium products alter the solubility. When Al ions are bound to bigger complexes the reaction is driven to the right, which indicates increased amount dissolved aluminium. The solubility at 20° C. for potassium alum in water is 0.6% Al. The solubility at 20° C. for a 50% alkalised potassium alum in water is 1.6% Al. Thus, the solubility has increased 2.67 times in this case, because of the alkalisation. In this way the heating of water may be eliminated.

After the product adaptation step I the obtained aluminium product may be re-used as chemical coagulant.

In a third embodiment of the present invention a RO concentrate is led from a sludge treatment construction to a alum crystallisation step C. In this case the sludge treatment construction B is a RO construction instead of a NF construction.

In a fourth embodiment of the present invention a MF or UF permeate is led from a sludge treatment construction to a alum crystallisation step C. In this case the sludge treatment construction B is a MF or UF construction B* instead of a NF construction B, and a permeate A*, instead of the concentrate A, is led to the alum crystallisation step C, in accordance with FIG. 1. As to the rest the process follows the embodiments described above.

During treatment of sludge from waterworks by membrane processes, the MF/UF permeate or the NF/RO concentrate will include iron and/or aluminium ions with sulphate ions as counter-ion, and also the dissolved heavy metal ions, which may occur in the raw water, which is treated in the waterworks, and will therefore also occur in the sludge from the waterworks. Accept for these heavy metals, which in most cases are constituted of divalent ios, such as Cu²⁺, Zn²⁺, and Ni²⁺, also dissolved organic substances occur.

The yield of reaction is favoured by a high concentration aluminium and/or iron ions, and therefore a concentration by NF or RO construction is preferred. Furthermore, the crystallisation (salting out) is favoured by increased pressure, which increases the yield. Moreover, if necessary, the solution may also be adjusted in respect of pH with sodium or potassium hydroxide, but not to such an extent that a precipitation of aluminium and/or iron hydroxide occurs.

In yet another embodiment of the present invention a sulphide compound is added to the sludge in connection to when the sludge is acidified, i.e. before the acidified sludge goes through a first membrane filtration process, to relieve the NF/RO step from possibly large amounts of heavy metals. This result in that the main part of the heavy metals is separated already at the MF/UF step, and will therefore be found in the organic permeate. Because of this the process of neutralising the filtrate G, from the alum separation step F, at regular intervals may be minimised. This also gives a higher yield Al for recycling. However, this method may only be used if an aluminium salt has been used as chemical coagulant, since aluminium, in contrast to iron, does not precipitate as metallic sulphide. Sodium sulphide or poly sulphide may be used as source of sulphide. During addition of sulphide ions these will, together with the heavy metal ions in the sludge, form very difficultly soluble metal sulphides. The metal sulphides are so stable that they to a very low extent will be dissolved in the acidified environment that the acidified sludge provides. The metal sulphides, which have been precipitated in this manner, will be kept in the MF or UF concentrate, whereby an almost metal free permeate is obtained.

The MF or UF permeate or NF or RO concentrate, which still contains organic substances, will, irrespective of if it is treated with sulphide or not, be oxidised in the manner described above, according to the crystallised precipitate.

Accordingly, a MF or UF permeate or NF or RO concentrate is obtained, which may be recirculated to the waterworks from which the sludge was generated.

1-11. (canceled)

12. A method for treatment of sludge, which comprises precipitated aluminium and/or iron hydroxide, whereby the sludge first is added acid and thereafter is subjected to at least one membrane filtration process, whereby a permeate or a concentrate is obtained, including trivalent aluminium and/or iron ions in solution, wherein the aluminium and/or iron ions in the permeate, or concentrate, are crystallised in a precipitation.

13. A method according to claim 12, wherein the precipitation is subjected to a product adaptation step.

14. A method according to claim 13, wherein the product adaptation step comprises an alkalisation.

15. A method according to claim 13, wherein an aluminium product from the product adaptation step may be reused, as a chemical coagulant, direct in a waterworks.

16. A method according to claim 12, wherein the crystallisation occurs by addition of potassium, sodium, and/or ammonium sulphate.

17. A method according to claim 12, wherein the crystallisation is performed at low temperature.

18. A method according to claim 12, wherein the crystallisation is performed after an adjustment of pH.

19. A method according to claims 18, wherein the pH is adjusted with potassium hydroxide, sodium hydroxide, sodium carbonate, magnesium hydroxide, magnesium oxide, or magnesium carbonate, separately or in combination.

20. A method according to claim 12, wherein the solution obtained from the crystallisation is used as chemical coagulant in similar industrial processes, such as paper industry or wastewater treatment plants.

21. Construction for treatment of sludge, which has been treated in a sludge treatment construction, whereby a permeate, or a concentrate, is obtained, wherein an alum crystallisation step to which the permeate, or concentrate, is led, and an alum separation step to which a solution is led.

22. Construction for treatment of sludge according to claim 21, wherein a product adaptation step to which a precipitate from the alum separation step is led.
